(19) United States
(12) Patent Application Publication
(10) Pub. No.: US 2022/0018549 A1
(43) Pub. Date: Jan. 20, 2022

(54) Protected infrared wall panel heating with flexible heating fabric

(71) Applicant: Alexander Slawinski, Marburg (DE)

(72) Inventor: Alexander Slawinski, Marburg (DE)

(21) Appl. No.: 17/311,645

(22) PCT Filed: Dec. 6, 2019
(86) PCT No.: PCT/EP2019/083947

§ 371 Date: Jun. 7, 2021

(30) Foreign Application Priority Data
Dec. 6, 2018 (DE) 10 2018 131 205.9

(51) Int. Cl. F24D 13/02; H05B 3/34; H05B 3/14; H05B 3/18; H05B 1/02

(52) U.S. Cl. CPC F24D 13/024; H05B 3/347; H05B 2203/032; H05B 3/18; H05B 1/0275; H05B 3/145

(57) ABSTRACT

Infrared wall panel heating with flexible heating fabric, in which a glass thread fabric is provided as the heating fabric, into which carbon threads are woven as the heating element and metallic electrical conductors, the metallic electrical conductors lying transversely to the carbon threads at both ends of the heating element and firmly looping around the carbon threads, and the heating element being electrically protected on both sides in each case by a layer of insulating foil. The wall panel heater is characterized in that at least two further layers of insulating foil and an additional layer of fleece and fabric are provided on both sides in each case for, in particular, mechanical protection of the heating element. The heater can thus be installed on a wall with direct connection to the local power supply network, in particular under plaster.

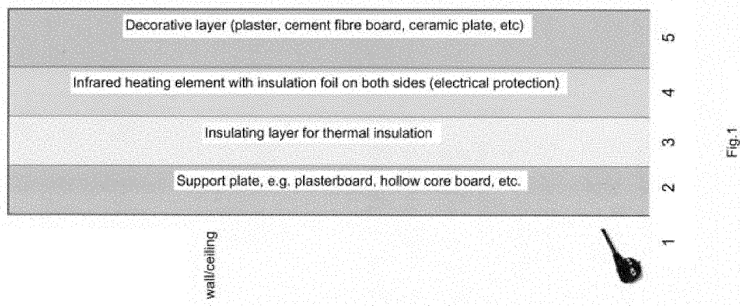

The invention relates to a protected infrared wall panel heating system with flexible heating fabric according to the preamble of claim 1. It relates to the field of electrothermics, in particular to an infrared wall panel heating system with flexible heating fabric, which at the same time fulfils the demands of humans for thermal comfort as well as for aesthetics.

Wall panel heaters are mainly used as infrared heaters in living rooms, factory halls and other similar facilities. Wall panel heaters can be retrofitted at any time and also have the property of emitting heat to a high degree in the form of radiation. They are electrically operated and are therefore not necessarily dependent on fossil fuels. This is very advantageous, as a rejection of oil and gas is becoming increasingly likely due to the rapidly advancing global warming. If the electrical energy to operate the wall panel heaters is generated by wind or water power or solar systems, a heating system is available entirely without harmful CO₂ emissions.

DE102010008449A1 describes a protected wall panel heating with flexible heating fabric, which is based on a novel flexible infrared heating fabric and is extremely light by using mainly non-metallic materials. A heater the size of about 1.4 m² weighs only 0.8 kg. There are no special requirements for the wall, on which pictures can also be hung.

The infrared radiation from the wall panel heating is emitted immediately after the heating is switched on. The wall panel heating has only a small storage mass and the warm-up time is very short. A temperature of 60° C. is reached after only five minutes. The user feels the pleasant radiant heat almost immediately.

Furthermore, the radiation warms people directly. This means that the heat does not have to be transported to the person by means of the heat transfer medium air. This means that the air temperature can also be significantly lower than with systems that work predominantly convectively, which results in a noticeable energy saving.

There are different infrared heating systems with which this can be realized. Reference is made to DE202006017492U1, DE202008007359U1, DE202009009228U1, DE10336427A1, DE102007039473A1 and DE 2445334A1. In floor, wall or ceiling heating systems, hot water-carrying pipes are integrated into the corresponding room enclosure surfaces. The heat is then dissipated directly to the surroundings (air) via a proportion (15-30%) in the form of convection. Compared to standard radiators, where the hot water is usually generated by oil or gas heating or by using a heat pump, the convection and thus the room air movement are significantly lower with infrared heating systems. However, the use of such heating systems should already be taken into account when planning the building. Although retrofitting these systems is not impossible, it does involve a considerable amount of construction work.

Wall panel heaters are a very good alternative to the aforementioned systems. Any type of room can be retrofitted with them at any time. However, the aforementioned infrared heaters have the disadvantage that they are very heavy, inflexible and, above all, expensive due to their construction. The main reason for the high weight is that materials such as steel plates or massive superstructures e.g., steel containers with sand fillings, are used. Such infrared heaters weigh up to 20 kg, and correspondingly load-bearing walls are required. Furthermore, the production of these heaters is characterized by many work steps and manual labor.

Known flexible composition heaters have significant shortcomings, have a short service life, or the manufacturing process is too complicated or too expensive.

DE9215471U1 and DE20008737U1 are known for heated wallpapers that can be heated by means of electric current. Metallic resistors are used. Large wall areas of up to 10-15 m² are required, and the heating elements are connected to direct current sources with up to 42 V. This means that very voluminous transformers are required. The installation of the heating elements and transformers requires a lot of work. The use of transformers also leads to high levels of electro smog, which can cause damage to health, and there may be higher maintenance and repair costs.

Also known by FR2171335 is a heating process in which the heating resistor element consists of non-metallic material (e.g. graphite) and the composite material e.g. of thermoactive resin. In particular, the uncontrolled and uneven contact of the metallic electrical conductors on graphite can lead to voltage peaks, which then eventually destroy the flexible composition heating. It burns out, so to speak. This defect can only be overcome in this process by elaborate sewing and targeted pressing of the conductor strips. This ultimately makes the flexible composition heating expensive.

Similar disadvantages also arise with a composition heater that has become known through RU2046552. In this composition heater, the resistance element consists of an insulating material (paper, cloth or similar material) with embossed carbon fibers. When the individual layers are pressed together, some carbon fibers may break. This results in an uneven temperature pattern. The heating performance is different for each flexible composition heater produced by this method. Furthermore, the contact between the metallic electrical conductors and the fabric can be classified as rather poor due to the unevenness of the fabric. Air inclusions cannot be ruled out, which then later lead to the formation of bubbles on the surface of the flexible composition heater. The procedure according to RU2046552 also does not get by without manual labor. Furthermore, different working surface temperatures result for carbon fibers (fleece) and metallic conductors (copper), which lead to air inclusions and then to short circuits.

Although the disadvantage of poor contact of the metallic electrical conductors with the flexible composition heating according to RU2088049 has been solved by electroplating the electrical conductors onto the resistance element, this process is extremely costly. Common materials, such as non-woven carbon papers as resistance element, cannot be used because they are damaged during the electroplating process.

In summary, it can be claimed that the flexible composition heaters described above have significant disadvantages.

However, DE102007039473A1 already discloses a heating of surfaces on sandwich elements and composite materials, in which the heating of the surfaces is carried out using a special glass fiber fabric, which is interwoven with carbon fibers as heating fabric, and in which the carbon fibers are heated by supplying current.

DE202009003858A1 further discloses a heating fabric consisting of weft and warp threads, wherein a part of the weft threads and/or warp threads consists of flexible conductive carbon fibers. Another part of the weft threads and/or warp threads consists of flexible synthetic fibers which fulfil a supporting function in the fabric. For energy supply, a third part of the weft threads and/or warp threads consists of metal threads that are coupled to a current source.

Furthermore, an electric heating element is known by DE758724, which consists of a fabric in which electric heating wires are inserted and in which the carrier of the wires consists of glass fibers.

Finally, infrared heaters are also known by DE202006017492U1, DE202008007358U1, DE202009009228U1, DE10336427A1 and DE2445334A1. For example, DE2006017492U1 has an infrared wall panel heater according to the generic term of claim 1. However, this heater is installed in a frame which is mounted on a wall and is exposed to mechanical damage. It can also only be operated according to DIN standard on a voltage up to 42 V and therefore requires heavy transformers for voltage reduction from the local power supply network.

The object of the invention is to provide a protected infrared wall panel heater of the type mentioned in the generic term of claim 1, with which the above-mentioned disadvantages are eliminated and with which, on the one hand, a safe contact of the metal conductors with the carbon filaments and, on the other hand, an effective protection of the heating element are achieved.

This task is solved by the features of claim 1.

The heating element is a glass filament fabric with woven-in carbon filaments, to which the metal conductors run transversely and wrap around them tightly. Furthermore, the heating element is electrically protected on both sides by at least two additional layers of insulation foil. Furthermore, additional layers of fleece and fabric are provided, in particular for mechanical protection. The protection is designed in such a way that damage to the heating element is not possible when trying to attach nails or screws to the heating element. The additional layers are placed on both sides of the wall panel heaters and glued together with the other layers, for example.

According to a further embodiment of the invention, the wall heating elements are directly connected to a power source of 230/110 V and mounted on a wall or laid flush on a wall.

According to a further advantageous embodiment of the invention, the carbon filaments consist of almost 100% carbon.

According to a further embodiment of the invention, the wavelength is in the range of 10 μm. This fulfils the best conditions for heat absorption and comfort. This wavelength is the decisive factor for the removal of perceptible heat.

The invention reveals a new way of heating, you don't see any heater, it is space-saving, has low costs of use and there are no CO₂ emissions. The heating panel with the integrated infrared heating element can be installed like a commercially available plasterboard e.g., as a wall element. The heating element/wall panel heater according to the invention may therefore be designed as a (for example drywall) wall element and may be referred to as such according to the present invention. Such a wall element may also comprise a corresponding wall panel heating according to the invention. In the installed state, this can preferably be flush on the surface with adjacent plaster-boards or other building materials forming wall surfaces.

The wall panel heating can have, for example, plaster, composite bricks or ferment fiber boards on its surface. These do not impair the functionality of the wall panel heating. Thus, the wall panel heating can be integrated completely invisibly into a wall or as part of a wall.

The wall element can therefore be an integral/structural part of a wall or its surface. For example, the wall element may subsequently form part of the (plastered) wall. Such a wall element may also be referred to as a wall surface heating according to the present invention or at least have such a wall surface heating. Particularly preferably, such a wall element has areas or provisions which allow a customary anchoring of the wall element. These may be, for example, plaster areas or other structural anchoring areas. Preferably, these may be provided at the edge of the wall element and provide, for example, a screw connection of the wall element to an underlying structure.

The wall element can be installed flush with the wall or ceiling or with a minimum distance of about 5 mm from the wall. The heating elements are preferably all the same.

As there is preferably an insulating foil behind the heating element, the heater has no losses via a rear radiation as well as a highest radiation portion almost only towards the front and thus a highest effect and a low convection at full effect. The heating element can be divided into several fields This can help, if someone penetrates the heater with a screw or a nail, that the heater is not destroyed and the driver does not get an electric shock. The thickness of the carbon filaments (non-metallic resistors) is preferably between 35 and 200 tex. There is no electro smog.

A supporting structure can be provided between the panels, which is designed to hold the heating element, which can also be referred to as infrared heating wall panel, by means of a screw connection to an underlying structure, for example drywall boarding or a support element. This can have a structural fabric and/or a solid building material such as plaster.

Preferably, gypsum plasterboard or wooden boards that have a minimal expansion when heated can be used as a carrier board. Not only glass threads, but also stone threads or similar, which have a temperature tolerance/resistance of about 100° C., can be used as support material. The work surface temperature is about 60-65° C. This means that there is no danger of burning. These are the best conditions for comfort. In terms of health and environmental aspects, the invention is unbeatable.

The wall panel heating can either be glued to the wall or hung with appropriate commercial hangers. The wall panel heating is extremely light due to the use of non-metallic materials. A wall panel heating with a size of 1.4^{m2} and a weight of 0.8 kg is preferred. The wall panel heating is designed in such a way that it requires a warm-up time of only five minutes to a temperature of 60° C. due to the low storage mass.

Furthermore, only high-quality materials and elements are used that are industrially available and can be processed mechanically. Accordingly, the wall panel heaters can be manufactured on the conveyor belt.

The invention will now be explained in more detail by means of an example of an embodiment. The single FIGURE shows the construction (a section) of an infrared wall panel heater.

The heater preferably consists of four main levels, one above the other, of which the upper level and the lower level are insulation levels 3, 5 and the middle level is a heating element level 4. The insulation levels 3, 5 are not shown in more detail. However, preferably 1, 2, 3 or more layers of insulation foil or fabric or fleece can be arranged in each of these.

In the heating element plane 4, a glass fiber fabric can be used as the base material, into which carbon threads can be woven. Transversely to these carbon threads, metallic electrical conductors in the form of metal threads can be woven into the glass fiber fabric, preferably on both sides. In this case, the metal threads preferably wrap tightly around the carbon threads. The metal threads are preferably connected at connection points with connecting leads, to which a connector plug 6 can be connected. A voltage of preferably 230 V or 110 V is supplied to the heating element via this plug. The metal threads, the carbon threads and the glass thread fabric are so loosely constructed that total failure damage by nails etc. is not possible.

When the wall panel heating is switched on, the infrared radiation can be emitted immediately afterwards at an angle of preferably 180° and heating to 60° C. takes place within less than five minutes because the wall panel heating has only a small storage mass. Typically, the work surface temperature is 65-70° C. The heat is radiated in the range of a wavelength of 8-10 μm. This provides the best conditions for heat absorption and comfort. The user feels the pleasant radiant heat almost immediately.

Air inclusions, localized voltage peaks and fluctuations in the heating power are ruled out, as is burning through of the flexible infrared wall panel heating and bubble formation on the surface. Shrinkage of the heating fabric cannot occur because glass threads are used as the base fabric.

Such a wall surface heating element typically has a size of only 1-1.4^{m2} and a weight of less than 1 kg. It can be attached to a wall 1 as an image, for example glued or hung. However, it can also fill the entire wall and thus form only one panel.

Preferably, it can be provided that the wall panel heating according to the invention has a surface area of up to 2 m×0.65 m, yet preferably has a power consumption which is as low as commercially available panel heaters with half the surface area (e.g. only 630 watts).

The wall panel heating according to the invention can also be plastered into the wall without spacers or can be attached to the wall with various cover materials (especially fabric). A wall panel heating system that is provided without spacing from the wall is not yet known. In this way, it can be achieved in particular that the heating radiates only to the front without convection (or convection arm).

Preferably, this is achieved in particular by using thin carbon fibres (preferably between 20 and 75 tex, preferably less than 75 tex). The carbon fibres can have a particular robustness.

Furthermore, a number of silver threads may be incorporated into the fabric of the 3,4 and/or 5 layer, the proportion of which to the total number of fibres in the layer is provided in the range of 5-20%.

For a full-surface radiation of heat radiation, it can be provided that (large)-area heating field(s) of heating conductors are arranged, which are divided into 2, 3, 4, 5 or more tracks. This can be beneficial for improved heat distribution.

A flexible foil is preferred, which can be provided as electrically safe, in particular as an insulator. This enables, for example, transformer-free operation of the wall heating at, for example, 240 V/110 V.

The effect of the advantages according to the invention is, for example, that it is possible to attach directly to the wall and/or larger areas with a heat requirement of, for example, up to 20 Watt/m² in new buildings and 40 Watt/m² in old buildings are less feasible.

1. Infrared wall panel heater with flexible heating fabric, in which a glass thread fabric is provided as the heating fabric, into which carbon threads are woven as a heating element and metallic electrical conductors, the metallic electrical conductors lying transversely to the carbon threads at both ends of the heating element and firmly looping around the carbon threads, and the heating element being electrically protected on both sides in each case by a layer of insulating foil,
wherein at least two further layers of insulating layers and an additional layer of fleece and fabric are provided on both sides in each case for the mechanical protection of the heating element.

2. Infrared wall panel heater according to claim 1, wherein the heating element is directly connected to a power source of 230/110 V and is installed on a wall.

3. Infrared wall panel heater according to claim 1, wherein the carbon filaments consist of almost 100% carbon.

4. Infrared wall panel heater according to claim 1,
wherein the heating element radiates in the range of a wave-length of 10 μm.

5. Infrared wall panel heater according to claim 1,
wherein the layer is made of a hard material, wherein the hard material is ceramic, mirror, plastic or granite.

6. Infrared wall panel heater according to claim 5,
wherein the heating element is directly connected to a power source of 230/110 V and is installed on a wall.

7. Infrared wall panel heater according to claim 5,
wherein the heating element is directly connected to a power source of 230/110 V and is installed on a wall under plaster.

8. Infrared wall panel heater according to claim 5,
wherein the carbon filaments consist of almost 100% carbon.

9. Infrared wall panel heater according to claim 5,
wherein the heating element radiates in the range of a wave-length of 10 μm.

10. Infrared wall panel heater according to claim 4,
wherein the heating element is directly connected to a power source of 230/110 V and is installed on a wall.

11. Infrared wall panel heater according to claim 4,
wherein the heating element is directly connected to a power source of 230/110 V and is installed on a wall under plaster.

12. Infrared wall panel heater according to claim 4,
wherein the carbon filaments consist of almost 100% carbon.

13. Infrared wall panel heater according to claim 1,
wherein the heating element is directly connected to a power source of 230/110 V and is installed on a wall under plaster.
